(19) United States
(12) Patent Application Publication
(10) Pub. No.: US 2026/0307649 A1
(43) Pub. Date: Oct. 8, 2026

(54) TRAJECTORY PLANNING METHOD AND APPARATUS, DEVICE AND STORAGE MEDIUM

(71) Applicant: Continental Autonomous Mobility Germany GmbH, Ingolstadt (DE)

(72) Inventors: Zhiying Shang, Shanghai (CN); Huan You, Putuo District (CN)

(73) Assignee: Continental Autonomous Mobility Germany GmbH, Ingolstadt (DE)

(21) Appl. No.: 19/108,322

(22) PCT Filed: Aug. 18, 2023
(86) PCT No.: PCT/EP2023/072833

§ 371 Date: Mar. 3, 2025

(30) Foreign Application Priority Data
Sep. 2, 2022 (CN) 202211074939.3

(51) Int. Cl. B60W 30/095; B60W 50/00; G05B 13/04

(52) U.S. Cl. CPC B60W 30/095; B60W 50/0097; B60W 50/0098; G05B 13/048; B60W 2050/0022; B60W 2050/0031; B60W 2510/20; B60W 2520/10; B60W 2520/14; B60W 2530/10; B60W 2710/207; B60W 2720/106

(57) ABSTRACT

The present disclosure provides a trajectory planning method and apparatus, a device, and a storage medium. The trajectory planning method includes the following steps: acquiring a reference trajectory of a predetermined planning interval on the basis of vehicle information, environment information and end point information; establishing a vehicle kinematic model in a road coordinate system on the basis of the vehicle information and the reference trajectory; using a model predictive controller to determine a sequence of control quantities in a predetermined planning interval according to the reference trajectory, the vehicle information and the vehicle kinematic model; obtaining a final trajectory on the basis of the sequence of control quantities. The present disclosure takes vehicle kinematic characteristics into account, and has low requirements for computing resources and a fast computing speed.

### CROSS-REFERENCE TO RELATED APPLICATIONS

The present application is a National Stage Application under 35 U.S.C. § 371 of International Patent Application No. PCT/EP2023/072833 filed on Aug. 18, 2023, and claims priority from Chinese Patent Application No. 202211074939.3 filed on Sep. 2, 2022, in the China National Intellectual Property Administration, the disclosures of which are herein incorporated by reference in their entireties.

### TECHNICAL FIELD

The present invention relates to the field of autonomous driving, in particular to a trajectory planning method and apparatus, a device and a storage medium.

### BACKGROUND

As artificial intelligence has developed, autonomous driving technology has also experienced massive development in recent years. To realize autonomous driving, multiple systems of central importance are required, including positioning, environmental perception, fused prediction, decision-making, planning and base-layer control, etc.; the trajectory planning system is one of these. The trajectory planning system needs to plan a trajectory that meets the dynamic requirements of the vehicle; this trajectory needs to satisfy decision-making layer instructions and be able to avoid collisions with surrounding obstacles.

As prior art, trajectory planning includes the following methods: using the method of enumerating a trajectory cluster and then screening out an optimal trajectory according to a cost function; establishing a neural network model, and using a machine learning method; the method of using geometric constraints to generate a random number of new nodes of a trajectory, and finally trimming the trajectory nodes and smoothing the trajectory; using the method of Hermite interpolation to perform trajectory planning in a select drivable region; and planning a safe and feasible travel trajectory by an improved artificial potential field method. However, the prior art mentioned above has problems, such as high computing costs, low computing efficiency, and failure to take into account vehicle kinematic or vehicle dynamic characteristics.

### SUMMARY

The present disclosure addresses the abovementioned problems; its objective is to provide a trajectory planning method and apparatus, as well as a device and a storage medium, which take into account vehicle kinematic characteristics, and have low requirements for computing resources and a fast computing speed.

According to one aspect of the present disclosure, a trajectory planning method is provided, including the following steps: acquiring a reference trajectory of a predetermined planning interval on the basis of vehicle information, environment information and end point information; establishing a vehicle kinematic model in a road coordinate system on the basis of the vehicle information and the reference trajectory; and using a model predictive controller to determine a sequence of control quantities in a predetermined planning interval according to the reference trajectory, the vehicle information and the vehicle kinematic model, and obtaining a final trajectory on the basis of the sequence of control quantities.

The step of using a model predictive controller to determine a sequence of control quantities in a predetermined planning interval according to the reference trajectory, the vehicle information and the vehicle kinematic model, and obtaining a final trajectory on the basis of the sequence of control quantities, includes: linearizing the vehicle kinematic model, to obtain a time domain linearized vehicle model and a space domain linearized vehicle model; the model predictive controller including a longitudinal control model and a transverse control model, designing a cost function of the longitudinal control model and a cost function of the transverse control model, and determining a sequence of control quantities of a predetermined planning interval on the basis of the cost function of the longitudinal control model, the cost function of the transverse control model, the time domain linearized vehicle model and the space domain linearized vehicle model; and acquiring a final trajectory on the basis of the sequence of control quantities.

The control quantities include: desired acceleration and desired front wheel deflection angle.

Based on a situation where the yaw angle φ and the deflection angle β of the centre of mass of the vehicle are small, the vehicle kinematic model is linearized to obtain the time domain linearized vehicle model and the space domain linearized vehicle model.

The longitudinal control model is established in the time domain, state quantities thereof include longitudinal position, speed and acceleration, and the sequence of desired accelerations among the control quantities is determined on the basis of the cost function of the longitudinal control model and the time domain linearized vehicle model.

The transverse control model is established in the space domain, state quantities thereof include transverse position, yaw angle and front wheel deflection angle, and the sequence of desired front wheel deflection angles among the control quantities is determined on the basis of the cost function of the transverse control model and the space domain linearized vehicle model.

The cost function of the longitudinal control model includes a first term and a second term, the first term representing minimization of state cost and control cost, and the second term representing end state cost.

The cost function of the transverse control model includes a third term and a fourth term, the third term representing minimization of state cost and control cost, and the fourth term representing end state cost.

The cost function of the longitudinal control model includes weights corresponding to longitudinal position error, speed error, acceleration error and desired acceleration.

The cost function of the transverse control model includes weights corresponding to transverse position error, yaw angle, front wheel deflection angle and desired front wheel deflection angle.

The step of acquiring a reference trajectory of a predetermined planning interval on the basis of vehicle information, environment information and end point information, includes: performing global trajectory planning on the basis of vehicle information and end point information, to obtain a global trajectory from a start point to an end point; and judging whether a collision will occur on the basis of environment information and the global trajectory; if a collision will occur, then performing local trajectory planning to obtain the reference trajectory; if no collision will occur, then acquiring the reference trajectory on the basis of the global trajectory.

According to another aspect of the present disclosure, a trajectory planning apparatus is provided, including: a reference trajectory acquisition module, configured to acquire a reference trajectory of a predetermined planning interval on the basis of vehicle information, environment information and end point information; a model establishing module, configured to establish a vehicle kinematic model in a road coordinate system on the basis of the vehicle information and the reference trajectory; and a final trajectory acquisition module, configured to use a model predictive controller to determine a sequence of control quantities in a predetermined planning interval according to the reference trajectory, the vehicle information and the vehicle kinematic model, and obtain a final trajectory on the basis of the sequence of control quantities.

According to another aspect of the present disclosure, an electronic device is provided, wherein the electronic device includes a processor and a memory, and at least one instruction or at least one program is stored in the memory, the at least one instruction or the at least one program being loaded by the processor and executing the trajectory planning method described above.

According to another aspect of the present disclosure, a computer storage medium is provided, wherein the computer storage medium stores an instruction for execution by a computing device, and when the computing device executes the instruction, the trajectory planning method described above is realized.

### BRIEF DESCRIPTION OF THE DRAWINGS

FIG. 1 is a schematic flow chart of a trajectory planning method provided in embodiments of the present disclosure.

FIG. 2 is a schematic drawing of parameters in a vehicle kinematic model provided in embodiments of the present disclosure.

FIG. 3 is a structural block diagram of the trajectory planning apparatus provided in embodiments of the present disclosure.

FIG. 4 is a structural block diagram of an electronic device provided in embodiments of the present disclosure.

### DETAILED DESCRIPTION

The present disclosure is described in further detail below with reference to the drawings and embodiments. It will be understood that the specific embodiments described here are merely used to explain the associated disclosure, without limiting it. It must also be explained that to facilitate description, only parts relevant to the associated disclosure are shown in the drawings.

The terms used herein are merely used to describe specific embodiments, and are not intended to limit the present disclosure. As used herein, the singular forms “a” and “the” are also intended to include the plural form, unless clearly indicated otherwise in the context. It will also be understood that when the terms “comprises” and/or “made of . . . ” are used herein, the existence of the mentioned feature, entity, step, operation, element and/or component is specified, without ruling out the existence or addition of one or more other features, entities, steps, operations, elements, components and/or groups thereof.

The embodiments mentioned herein may be described with reference to planar drawings and/or sectional drawings with the aid of the ideal schematic drawings of the present disclosure. Thus, exemplary drawings may be modified according to manufacturing techniques and/or tolerances. Therefore, the embodiments are not limited to the embodiments shown in the drawings, but include modifications to configurations formed on the basis of manufacturing processes. For this reason, regions illustrated in the drawings have schematic attributes, and the shapes of the regions shown in the drawings illustrate specific shapes of regions of elements, but are not intended to be limiting.

Unless otherwise defined, all terms used herein (including technical and scientific terms) have the same meanings as commonly understood by those skilled in the art. It will also be understood that terms such as those defined in common dictionaries should be interpreted as having the same meanings as they have in the context of the present disclosure and the related art, and shall not be interpreted as having idealized or excessively formal meanings, unless explicitly defined in this way herein.

Embodiments of the present application provide a trajectory planning method, in which a vehicle 1 can compute a smooth trajectory according to information about the vehicle itself, a target state, road condition information about a road, and dynamic and comfort constraints, so that the vehicle 1 can reach the target state along this trajectory.

FIG. 1 is a schematic flow chart of the trajectory planning method provided in embodiments of the present disclosure; the method may be executed by a trajectory planning apparatus, which may be realized by software and/or hardware. This description provides method operating steps according to the embodiments or flow chart, but may include a larger or smaller number of operating steps, based on conventional or non-creative effort. The order of the steps set out in the embodiments is merely one of many orders in which steps may be executed, and does not represent the only order of execution. When executed in an actual system or server product, the steps may be executed in the order of the method shown in the embodiments or drawings, or executed in parallel (for example, parallel processors or a multi-thread processing environment).

As shown in FIG. 1, the trajectory planning method provided in this embodiment includes the following steps.

S110: acquiring a reference trajectory of a predetermined planning interval on the basis of vehicle information, environment information and end point information.

In this embodiment, global trajectory planning may be performed first, on the basis of vehicle information and end point information, to obtain a global trajectory from a start point to an end point, and preliminarily determine a position and speed of the vehicle 1 at each moment. Local trajectory planning is then performed; in the process of local trajectory planning, the already-planned global trajectory is used as a basis, then small-range, small-timescale trajectory planning is performed with reference to obstacle information acquired by various sensors, so as to obtain a reference trajectory of a predetermined planning interval.

The global trajectory planning in this embodiment may use third-degree polynomial interpolation to obtain the global trajectory. The global trajectory planning method used in this embodiment is prior art in this field, so details are not repeated here.

In this embodiment, each time global trajectory planning is performed, the current position of the vehicle is taken to be the start point of the global trajectory planning. Thus, the displacement and time of the start point are both 0; therefore, the position and time of the end point are the distance and time separating the start point and end point, and are independent of absolute coordinates.

After obtaining the global trajectory, a judgment is made as to whether a collision will occur on the basis of environment information and the global trajectory. If a collision will occur, then local trajectory planning is performed, to obtain a reference trajectory of a predetermined planning interval. If no collision will occur, a reference trajectory of a predetermined planning interval is acquired on the basis of the global trajectory. Specifically, a trajectory of a predetermined planning interval may be screened out of the global trajectory to serve as a reference trajectory.

The predetermined planning interval in this electric machine may be a reference trajectory of a predetermined length, or a reference trajectory of a predetermined duration.

S120: a vehicle kinematic model in a road coordinate system is established on the basis of the vehicle information and the reference trajectory.

The road coordinate system is also called the Frenet coordinate system. The vehicle kinematic model in the road coordinate system has the road start point as the origin of coordinates, the road direction as the s direction, and the direction perpendicular to a tangent to the road as the l direction; the coordinates are expressed as (s,l). In this embodiment, the reference trajectory obtained in step S110 is used as a reference coordinate system. Therefore, the start point (or any point) of the reference trajectory is used as the origin of the coordinate system, the direction along the reference trajectory is s, and the direction perpendicular to the trajectory is l.

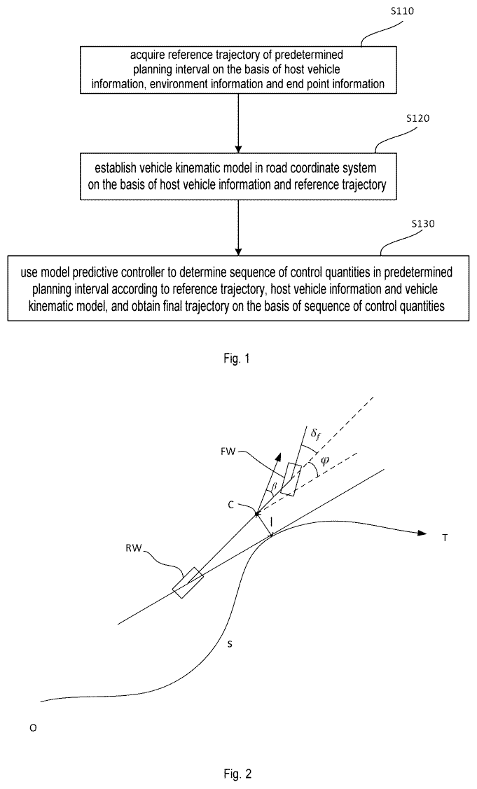

FIG. 2 is a schematic drawing of parameters in the vehicle kinematic model in the road coordinate system as provided in embodiments of the present disclosure.

As shown in FIG. 2, the trajectory T is the reference trajectory, and the start point O of the reference trajectory is chosen to be the origin of the coordinate system. Point C in FIG. 2 represents the centre of mass of the vehicle, and the coordinates (s, l) of the centre of mass of the vehicle are taken to be the coordinates of the vehicle, i.e. the longitudinal position of the vehicle is s, and the transverse position of the vehicle is l. In addition, RW in FIG. 2 represents the rear wheels of the vehicle, FW represents the front wheels of the vehicle, φ represents the yaw angle of the vehicle, δ_{f} represents the deflection angle of the front wheels, and B represents the deflection angle of the centre of mass of the vehicle.

Vehicle state quantities include:
longitudinal position (position in the direction of the reference trajectory): s
transverse position (position in the direction perpendicular to the reference trajectory): l
yaw angle: φ
speed: v
acceleration: a
deflection angle of front wheels: δ_{f}
Vehicle control quantities include:
desired acceleration: a_{com}
desired deflection angle of front wheels: δ_{f} _{_{com}}

The vehicle kinematic model shown in formula (a) below is obtained by differentiation of the vehicle state quantities:

$${s}_{t + 1} = {s}_{t} + {v}_{t} cos ( {φ}_{t} + {β}_{t} ) \times Δ t \times cos ( {lon\_slope}_{t} ) \qquad ( 1 )$$

$${l}_{t + 1} = {l}_{t} + {v}_{t} sin ( {φ}_{t} + {β}_{t} ) \times Δ t \times cos ( {lat\_slope}_{t} )$$

$${v}_{t + 1} = {v}_{t} + {a}_{t} \times Δ t$$

$${φ}_{t + 1} = {φ}_{t} + {v}_{t} ( \frac{cos {β}_{t} tan {δ}_{{f}_{t}}}{w} - {k}_{t} ) \times Δ t$$

where t represents time, the subscript t+1 represents the state at time t+1, the subscript t represents the state at time t, w represents the wheelbase of the vehicle, kt is the curvature of the reference trajectory, lon_slopeₜ is the longitudinal slope of the road (in units of radians), and lat_slopeₜ is the transverse slope of the road (in units of radians).

S130: a model predictive controller is used to determine a sequence of control quantities in a predetermined planning interval according to the reference trajectory, vehicle information and the vehicle kinematic model, and a final trajectory is obtained on the basis of the sequence of control quantities.

Firstly, the vehicle kinematic model shown in formula (1) above is linearized, to obtain a time domain linearized vehicle model and a space domain linearized vehicle model.

Specifically, a first-order inertial process is used to fit the step response of acceleration and front wheel deflection angle, giving:

$${a}_{t + 1} = {a}_{t} + \frac{{a}_{{com}_{t}} - {a}_{t}}{{τ}_{a}} \times Δ t$$

$${δ}_{{f}_{t + 1}} = {δ}_{{f}_{t}} + \frac{{δ}_{{f}_{{com}_{t}}} - {δ}_{{f}_{t}}}{{τ}_{{δ}_{f}}} \times Δ t$$

When the front wheel deflection angle is small, the yaw angle φ and the deflection angle β of the centre of mass of the vehicle are small; therefore, vehicle motion exhibits only slight non-linearity, and linear modeling of the vehicle kinematic model is reasonable.

If the yaw angle φ and the deflection angle β of the centre of mass of the vehicle are small, the following reasonable assumptions hold:

$$cos ( {φ}_{t} + {β}_{t} ) \approx 1 ; sin ( {φ}_{t} + {β}_{t} ) \approx φ ; cos {β}_{t} \approx 1 ; tan {δ}_{{f}_{t}} = \frac{sin {δ}_{{f}_{t}}}{cos {δ}_{{f}_{t}}} \approx {δ}_{{f}_{t}}$$

Applying the reasonable assumptions above, the vehicle kinematic model shown in formula (1) is linearized, to obtain the time domain linearized vehicle model shown in formula (2).

$${s}_{t + 1} = {s}_{t} + {v}_{t} \times Δ t \times cos ( {lon\_slope}_{t} ) \qquad ( 2 )$$

$${l}_{t + 1} = {l}_{t} + {v}_{t} {φ}_{t} \times Δ t \times cos ( {lat\_slope}_{t} )$$

$${v}_{t + 1} = {v}_{t} + {a}_{t} \times Δ t$$

$${φ}_{t + 1} = {φ}_{t} + {v}_{t} ( \frac{{δ}_{{f}_{t}}}{w} - {k}_{t} ) \times Δ t$$

$${a}_{t + 1} = {a}_{t} + \frac{{a}_{{com}_{t}} - {a}_{t}}{{τ}_{a}} \times Δ t$$

$${δ}_{{f}_{t + 1}} = {δ}_{{f}_{t}} + \frac{{δ}_{{f}_{{com}_{t}}} - {δ}_{{f}_{t}}}{{τ}_{{δ}_{f}}} \times Δ t$$

Since

$${s}_{t + 1} - {s}_{t} = v \times Δ t , Δ t = \frac{Δ s}{v} ;$$

this is substituted into the time domain linearized vehicle model above to obtain a space domain linearized vehicle model as shown in formula (3) below:

$${t}_{s + 1} = {t}_{s} + \frac{1}{{v}_{s}} \times Δ s \qquad ( 3 )$$

$${l}_{s + 1} = {l}_{s} + {φ}_{s} \times Δ s \times cos ( {lat\_slope}_{s} )$$

$${v}_{s + 1} = {v}_{s} + \frac{1}{{v}_{s}} {a}_{s} \times Δ s$$

$${φ}_{s + 1} = {φ}_{s} + ( \frac{{δ}_{{f}_{s}}}{w} - {k}_{s} ) \times Δ s$$

$${a}_{s + 1} = {a}_{s} + \frac{{a}_{{com}_{t}} - {a}_{t}}{{τ}_{a}} \frac{1}{{v}_{s}} \times Δ s$$

$${δ}_{{f}_{s + 1}} = {δ}_{{f}_{s}} + \frac{{δ}_{{f}_{{com}_{s}}} - {δ}_{{f}_{s}}}{{τ}_{{δ}_{f}}} \frac{1}{{v}_{s}} \times Δ s$$

The model predictive controller used in this embodiment includes a longitudinal control model and a transverse control model; a cost function of the longitudinal control model and a cost function of the transverse control model are designed separately.

The cost function of the longitudinal control model is shown in formula (4) below:

$${min}_{u} ( {\sum }_{k = 0}^{N - 1} {\underbrace{[ \begin{matrix}{Q}_{{lon}_{1}} & 0 & 0 \\ 0 & {Q}_{{lon}_{2}} & 0 \\ 0 & 0 & {Q}_{{lon}_{3}}\end{matrix} ] \times {( {ξ}_{{lon}_{k}} - {ξ}_{{lon}_{k}}^{ref} )}^{2}}}_{state cost} + {\underbrace{{R}_{lon} {u}_{{lon}_{k}}^{2}}}_{control cost} ) + {\underbrace{[ \begin{matrix}{Q}_{{lon}_{1}}^{N} & 0 & 0 \\ 0 & {Q}_{{lon}_{2}}^{N} & 0 \\ 0 & 0 & {Q}_{{lon}_{3}}^{N}\end{matrix} ] \times {( {ξ}_{{lon}_{N}} - {ξ}_{{lon}_{N}}^{ref} )}^{2}}}_{end state cost} \qquad ( 4 )$$

The cost function of the longitudinal control model shown in formula (4) includes a first term and a second term, i.e. the term preceding the plus sign and the term following the plus sign in formula (4). The first term represents minimization of the state cost and the control cost, i.e. bringing the system as close as possible to the reference state quantity while consuming as little energy as possible. The state quantity of the longitudinal control model of the model predictive controller is ξₗₒₙ=[s, v, a], i.e. includes longitudinal position, speed and acceleration, the control quantity is uₗₒₙ=a_{com}, i.e. desired acceleration, and the reference state quantity is

$${ξ}_{{lon}_{k}}^{ref} = [ {s}_{k}^{ref} , {v}_{k}^{ref} , {a}_{k}^{ref} ] .$$

The first term of the cost function of the longitudinal control model is the sum of the state cost and the control cost of each step from step k=0 to step k=N−1, wherein the state cost of each step is as follows:

$${{Q}_{{lon}_{1}} ( {s}_{k} - {s}_{k}^{ref} )}^{2} + {{Q}_{{lon}_{2}} ( {v}_{k} - {v}_{k}^{ref} )}^{2} + {{Q}_{{lon}_{3}} ( {a}_{k} - {a}_{k}^{ref} )}^{2}$$

where Qₗₒₙ_{₁}, Qₗₒₙ_{₂} and Qₗₒₙ_{₃} are preset constants, respectively representing weight factors of longitudinal position error, speed error and acceleration error in the cost. In this embodiment, acceleration is not planned in the reference trajectory, so

$${a}_{k}^{ref} = 0 ,$$

### and Qₗₒₙ_{₃} is set to 0.

The control cost of each step is Rₗₒₙa_{com}_{ₖ}², Rₗₒₙ being the weight factor of desired acceleration in the cost.

The second term represents the end state cost, which is intended to take into account a scenario in which the vehicle must forcibly reach a particular state at a particular time; the expanded form thereof is as follows:

$${{Q}_{{lon}_{1}}^{N} ( {s}_{N} - {s}_{N}^{ref} )}^{2} + {{Q}_{{lon}_{2}}^{N} ( {v}_{N} - {v}_{N}^{ref} )}^{2} + {{Q}_{{lon}_{3}}^{N} ( {a}_{N} - {a}_{N}^{ref} )}^{2}$$

where

$${Q}_{{lon}_{1}}^{N} , {Q}_{{lon}_{2}}^{N} and {Q}_{{lon}_{3}}^{N}$$

are weight factors of the end state cost in the cost function.

The longitudinal control model is established in the time domain, and the state quantity thereof includes longitudinal position, speed and acceleration as stated above, while the control quantity is desired acceleration.

Thus, based on the time domain linearized vehicle model shown in formula (2), a system dynamic equation of the longitudinal control model may be obtained, as shown in formula (5) below:

$${s}_{k + 1} = {s}_{k} + {v}_{k} \times Δ t \times cos ( {lon\_slope}_{t} ) \qquad ( 5 )$$

$${v}_{k + 1} = {v}_{k} + {a}_{k} \times Δ t$$

$${a}_{k + 1} = {a}_{k} + \frac{{a}_{{com}_{k}} - {a}_{k}}{{τ}_{a}} \times Δ t$$

Thus, based on the cost function of the longitudinal control model shown in formula (4) and the system dynamic equation (5) of the longitudinal control model, a sequence of desired accelerations in the control quantity can be determined.

The cost function of the transverse control model is shown in formula (6) below:

$${min}_{{u}_{lat}} ( {\sum }_{k = 0}^{N - 1} {\underbrace{[ \begin{matrix}{Q}_{{lat}_{1}} & 0 & 0 \\ 0 & {Q}_{{lat}_{2}} & 0 \\ 0 & 0 & {Q}_{{lat}_{3}}\end{matrix} ] \times {( {ξ}_{{lat}_{k}} - {ξ}_{{lat}_{k}}^{ref} )}^{2}}}_{state cost} + {\underbrace{{R}_{lat} {u}_{{lat}_{k}}^{2}}}_{control cost} ) + {\underbrace{[ \begin{matrix}{Q}_{{lat}_{1}}^{N} & 0 & 0 \\ 0 & {Q}_{{lat}_{2}}^{N} & 0 \\ 0 & 0 & {Q}_{{lat}_{3}}^{N}\end{matrix} ] \times {( {ξ}_{{lat}_{N}} - {ξ}_{{lat}_{N}}^{ref} )}^{2}}}_{end state cost} \qquad ( 6 )$$

The cost function of the transverse control model shown in formula (6) includes a third term and a fourth term, i.e. the term preceding the plus sign and the term following the plus sign in formula (6). Similarly, the third term represents minimization of the state cost and the control cost, i.e. bringing the system as close as possible to the reference state quantity while consuming as little energy as possible. The state quantity of the transverse control model of the model predictive controller is ξₗₐₜ=[l, φ, δ_{f}], i.e. includes transverse position, yaw angle and front wheel deflection angle; the control quantity is uₗₐₜ=δ_{f}_{_{com}}, i.e. the front wheel deflection angle. Since l and φ of the state quantity are already errors, and the front wheel deflection angle δ_{f} is not planned in the reference trajectory, the transverse reference state quantity is

$${ξ}_{{lat}_{k}}^{ref} = [ 0 , 0 , 0 ] .$$

The state cost of each step is as follows:

$${{Q}_{{lat}_{1}} ( {l}_{k} )}^{2} + {{Q}_{{lat}_{2}} ( {φ}_{k} )}^{2} + {{Q}_{{lat}_{3}} ( {δ}_{{f}_{k}} )}^{2}$$

Qₗₐₜ_{₁}, Pₗₐₜ_{₂} and Qₗₐₜ_{₃} are preset constants, respectively representing weight factors of the transverse position error relative to the reference trajectory, the yaw angle and the front wheel deflection angle in the cost.

The fourth term represents the end state cost, intended to take into account a scenario in which the vehicle must forcibly reach a particular state at a particular time; Rₗₐₜ is the weight factor of desired front wheel deflection angle.

$${Q}_{{lat}_{1}}^{N} , {Q}_{{lat}_{2}}^{N} and {Q}_{{lat}_{3}}^{N}$$

are weight factors of the end state cost in the cost function. Deflection angle values for the front wheels of the vehicle are not planned in the reference trajectory in this embodiment, so

$${Q}_{{lat}_{3}} = {Q}_{{lat}_{3}}^{N} = 0.$$

The transverse control model is established in the space domain; the state quantity thereof includes transverse position error, yaw angle and front wheel deflection angle as stated above, and the control quantity is desired acceleration.

Thus, based on the space domain linearized vehicle model shown in formula (3), a system dynamic equation of the transverse control model may be obtained, as shown in formula (7) below:

$${l}_{s + 1} = {l}_{s} + {φ}_{s} \times Δ s \times cos ( {lat\_slope}_{s} ) \qquad ( 7 )$$

$${φ}_{s + 1} = {φ}_{s} + \frac{{δ}_{{f}_{s}}}{w} - {k}_{s} \times Δ s$$

$${δ}_{{f}_{s + 1}} = {δ}_{{f}_{s}} + \frac{{δ}_{{f}_{{com}_{s}}} - {δ}_{{f}_{s}}}{{τ}_{{δ}_{f}}} \frac{1}{{v}_{s}} \times Δ s$$

Thus, based on the cost function of the transverse control model shown in formula (6) and the system dynamic equation (7) of the transverse control model, a sequence of desired front wheel deflection angles in the control quantity can be determined.

Finally, based on the sequences of control quantities obtained by means of the longitudinal control model and transverse control model, i.e. the sequences of desired accelerations and desired front wheel deflection angles, an optimized final trajectory can be acquired.

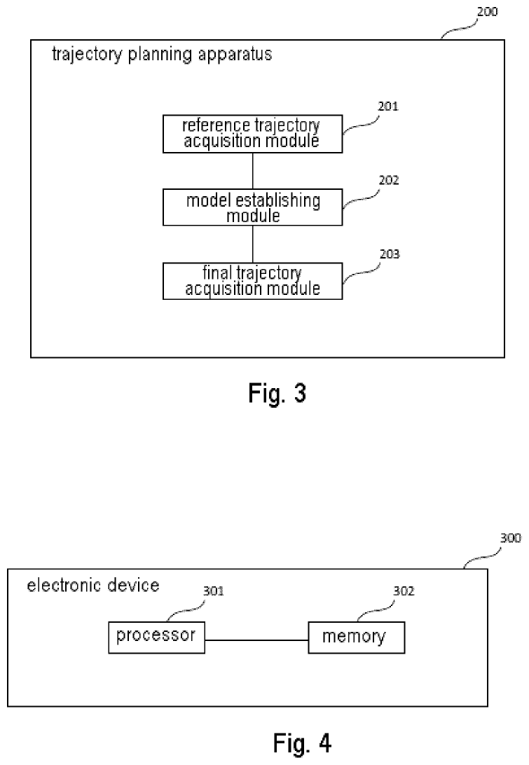

FIG. 3 is a structural block diagram of the trajectory planning apparatus provided in embodiments of the present disclosure.

As shown in FIG. 3, the trajectory planning apparatus 200 includes: a reference trajectory acquisition module 201, a model establishing module 202 and a final trajectory acquisition module 203.

The reference trajectory acquisition module 201 is configured to acquire a reference trajectory of a predetermined planning interval on the basis of vehicle information, environment information and end point information. Global trajectory planning may be performed first, on the basis of vehicle information and end point information, to obtain a global trajectory from a start point to an end point, and preliminarily determine a position and speed of the vehicle 1 at each moment. Local trajectory planning is then performed; in the process of local trajectory planning, the already-planned global trajectory is used as a basis, then small-range, small-timescale trajectory planning is performed with reference to obstacle information acquired by various sensors, so as to obtain a reference trajectory of a predetermined planning interval. The model establishing module 202 is configured to establish a vehicle kinematic model in a road coordinate system on the basis of vehicle information and the reference trajectory. The final trajectory acquisition module 204 is configured to use a model predictive controller to determine a sequence of control quantities in a predetermined planning interval according to the reference trajectory, vehicle information and the vehicle kinematic model, and obtain a final trajectory on the basis of the sequence of control quantities.

FIG. 4 is a structural block diagram of an electronic device 300 provided in embodiments of the present disclosure. As shown in FIG. 4, the present disclosure further provides an electronic device 300, the electronic device 300 including a processor and a memory; at least one instruction or at least one program is stored in the memory, the at least one instruction or the at least one program being loaded by the processor and executing the local trajectory planning method described in the embodiments above.

The present disclosure further provides a computer storage medium, in which is stored at least one instruction or at least one program, the at least one instruction or at least one program being loaded and executed by the processor to realize the lane structure fusion method described in the embodiments above.

Optionally, in this embodiment, the storage medium may be located in at least one of multiple network servers of a computer network. Optionally, in this embodiment, the storage medium may include but is not limited to various media capable of storing program code, such as a USB stick, read-only memory (ROM), random access memory (RAM), external hard drive, magnetic disk or optical disk.

Those skilled in the art should be able to realize that the modules, units and method steps in the examples described with reference to the embodiments disclosed herein can be realized with electronic hardware, computer software or a combination of both. In order to clearly explain the interchangeability of electronic hardware and software, the composition and steps of each example have already been described in general terms according to functions in the description above. Whether these functions are ultimately executed with electronic hardware or software depends on the specific application of the technical solution and design constraints. Those skilled in the art may use different methods to implement the described functions for each specific application, but such implementations should not be regarded as exceeding the scope of the present disclosure.

Although the present disclosure has been described with reference to the current particular embodiments, those skilled in the art should realize that the inventive scope involved in the present disclosure is not limited to the technical solution formed by a specific combination of the technical features mentioned above, and should also encompass other technical solutions formed by any combination of the abovementioned technical features or their equivalent features without departing from the inventive concept. Examples are technical solutions formed by mutual replacement of the abovementioned features and technical features disclosed in the present disclosure and (but not limited to) having similar functions.

1. A trajectory planning method, comprising the following steps:
acquiring a reference trajectory of a predetermined planning interval on the basis of vehicle information, environment information and end point information;
establishing a vehicle kinematic model in a road coordinate system on the basis of the vehicle information and the reference trajectory; and
using a model predictive controller to determine a sequence of control quantities in a predetermined planning interval according to the reference trajectory, the vehicle information and the vehicle kinematic model, and obtaining a final trajectory on the basis of the sequence of control quantities.

2. The trajectory planning method as claimed in claim 1, wherein using a model predictive controller to determine a sequence of control quantities in a predetermined planning interval according to the reference trajectory, the vehicle information and the vehicle kinematic model, and obtaining a final trajectory on the basis of the sequence of control quantities, comprises:
linearizing the vehicle kinematic model, to obtain a time domain linearized vehicle model and a space domain linearized vehicle model;
wherein the model predictive controller comprises a longitudinal control model and a transverse control model, designs a cost function of the longitudinal control model and a cost function of the transverse control model, and determines a sequence of control quantities of a predetermined planning interval on the basis of the cost function of the longitudinal control model, the cost function of the transverse control model, the time domain linearized vehicle model and the space domain linearized vehicle model; and
acquiring a final trajectory on the basis of the sequence of control quantities.

3. The trajectory planning method as claimed in claim 2, wherein
the control quantities comprise: desired acceleration and desired front wheel deflection angle.

4. The trajectory planning method as claimed in claim 3, wherein based on a situation where a yaw angle φ and a deflection angle β of a center of mass of the vehicle are small, and the vehicle kinematic model is linearized to obtain the time domain linearized vehicle model and the space domain linearized vehicle model.

5. The trajectory planning method as claimed in claim 3, wherein the longitudinal control model is established in the time domain, state quantities thereof comprise longitudinal position, speed and acceleration, and the sequence of desired accelerations among the control quantities is determined on the basis of the cost function of the longitudinal control model and the time domain linearized vehicle model.

6. The trajectory planning method as claimed in claim 3, wherein the transverse control model is established in the space domain, state quantities thereof comprise transverse position, yaw angle and front wheel deflection angle, and the sequence of desired front wheel deflection angles among the control quantities is determined on the basis of the cost function of the transverse control model and the space domain linearized vehicle model.

7. The trajectory planning method as claimed in claim 5, wherein the cost function of the longitudinal control model comprises a first term and a second term, the first term representing minimization of state cost and control cost, and the second term representing end state cost.

8. The trajectory planning method as claimed in claim 6, wherein
the cost function of the transverse control model comprises a third term and a fourth term, the third term representing minimization of state cost and control cost, and the fourth term representing end state cost.

9. The trajectory planning method as claimed in claim 5, wherein the cost function of the longitudinal control model comprises weights corresponding to longitudinal position error, speed error, acceleration error and desired acceleration.

10. The trajectory planning method as claimed in claim 6, wherein the cost function of the transverse control model comprises weights corresponding to transverse position error, yaw angle, front wheel deflection angle and desired front wheel deflection angle.

11. The trajectory planning method as claimed in claim 1, wherein acquiring a reference trajectory of a predetermined planning interval on the basis of vehicle information, environment information and end point information, comprises:
performing global trajectory planning on the basis of the vehicle information and the end point information, to obtain a global trajectory from a start point to an end point; and
judging whether a collision will occur on the basis of the environment information and the global trajectory;
if a collision will occur, then performing local trajectory planning to obtain the reference trajectory;
if no collision will occur, then acquiring the reference trajectory on the basis of the global trajectory.

12. A trajectory planning apparatus, comprising:
a reference trajectory acquisition module, configured to acquire a reference trajectory of a predetermined planning interval on the basis of vehicle information, environment information and end point information;
a model establishing module, configured to establish a vehicle kinematic model in a road coordinate system on the basis of the vehicle information and the reference trajectory; and
a final trajectory acquisition module, configured to use a model predictive controller to determine a sequence of control quantities in a predetermined planning interval according to the reference trajectory, the vehicle information and the vehicle kinematic model, and obtain a final trajectory on the basis of the sequence of control quantities.

13. An electronic device, wherein the electronic device comprises a processor and a memory, and at least one instruction or at least one program is stored in the memory, the at least one instruction or the at least one program being loaded by the processor and executing the method as claimed in claim 1.

14. A non-transitory computer storage medium, wherein the computer storage medium stores an instruction for execution by a computing device, and when the computing device executes the instruction, the method as claimed in any one of claim 1 is performed.
